(19) United States
(12) Patent Application Publication
(10) Pub. No.: US 2025/0363212 A1
(43) Pub. Date: Nov. 27, 2025

(54) INLINE SECURITY PLATFORM WITH EXTERNAL PLATFORM INTEGRATION

(71) Applicant: Aurascape, Santa Clara, CA (US)

(72) Inventors: Liang Li, Cupertino, CA (US); Nidhi Shah, Santa Clara, CA (US); Xingsi Zhong, Santa Clara, CA (US); Liang Guo, Santa Clara, CA (US); Jean-Luc Nacif Coelho, Santa Clara, CA (US)

(21) Appl. No.: 19/214,854

(22) Filed: May 21, 2025

Related U.S. Application Data
(60) Provisional application No. 63/650,217, filed on May 21, 2024.

(51) Int. Cl. G06F 21/55

(52) U.S. Cl. CPC G06F 21/554; G06F 2221/033

(57) ABSTRACT

Methods, systems, and apparatus, including computer programs encoded on computer storage media, for computerized security platforms. In some implementations, an inline security platform obtains data transmitted between a client platform and an external platform through the inline security platform. The inline security platform determines whether one or more actions performed by the external platform on the transmitted data violates one or more security policies. In response to determining that at least one of the security policies has been violated, the inline security platform performs an operation on the transmitted data within the external platform to remedy the violation of the one or more security policies. The inline security platform provides a notification representing the operation being performed to remedy the violation of the one or more security policies.

### CROSS-REFERENCE TO RELATED APPLICATIONS

This application claims the benefit of U.S. Provisional Application No. 63/650,217, filed on May 21, 2024, which is incorporated herein by reference.

### TECHNICAL FIELD

This disclosure relates generally to computerized security platforms.

### BACKGROUND

Communications between end users, such as client devices, and remote applications, such as applications hosted by network servers, carry security risks. The security risks include access control, leakage of users or companies' intellectual property, or sensitive data, exposure to harmful content, among others. The risks can be greater when the remote applications expose content to other remote or third party applications.

### SUMMARY

In accordance with the techniques described herein, a computerized security platform can regulate the use of one or more computer systems by one or more client devices. As an example, a computerized security platform can selectively permit one or more users via their client devices and/or computer systems to access one or more other computer systems (e.g., via a communications network). In some examples, the computerized security platform can selectively restrict one or more users and/or computer systems from accessing one or more other computer systems. In some implementations, a computerized security platforms can operate in accordance with one or more security policies, e.g., sets of rules specifying the manner by which use of one or more computer systems are to be controlled by the computerized security platform.

The present disclosure describes methods and systems for a security platform that is deployed between client devices and one or more external platforms that the client devices communicate with to use applications hosted by the external platforms. The security platform is hosted in a network and acts as a proxy in the network connections between the client devices and the external platforms. In some examples, the security platform can perform one or more operations that monitor communications between the client devices and the one or more external platforms and perform security operations on the data in accordance with one or more security policies found on the security platform. In some examples, the security platform can perform one or more security operations by accessing data on the external platforms and determine whether the data on the external platform is in accordance with the one or more security policies found on the security platform.

In some examples, the security platform can access the data on the external platforms through an application programmable interface and analyze whether the data violates the one or more security policies. If the security platform determines that the data on the external platforms is in violation of the one or more security policies, for example, then the security platform can perform various actions to secure the data on the external platform. This can include, for example, removing the data from the external platform, disconnecting one or more third parties connected to the external platform from accessing the stored data, removing outsiders access to the data on the external platform, and notifying an administrator or user of the data in violation of the one or more security policies.

In this manner, the security platform can monitor not only inline communication between the client devices and the external platforms but also monitor data stored on external platforms for security violations. The security platform can ensure comprehensive data governance and allow for meticulous tracking of data across network. The security platform can provide data tracking capabilities that offer a detailed auditing of data movement, data origination, and storage of data. As a result, the capabilities offered by the security platform can allow for a thorough review of data stored on the external platforms and data communicated to the external platforms for verification and validation purposes.

In one general aspect, a method is performed by a server. The method includes: obtaining, by an inline security platform, data transmitted between a client platform and an external platform through the inline security platform; determining, by the inline security platform, whether one or more actions performed by the external platform on the transmitted data violates one or more security policies; in response to determining that at least one of the one or more actions performed by the external platform on the transmitted data violates the one or more security policies, performing, by the inline security platform, an operation on the transmitted data within the external platform to remedy the violation of the one or more security policies; and providing, by the inline security platform, a notification representing the operation being performed to remedy the violation of the one or more security policies.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, performing the operation on the transmitted data within the external platform includes: accessing, by the inline security platform, an application programming interface (API) of the external platform; and executing one or more functions through the API to perform the operation within the external platform.

In some implementations, the one or more functions of the API are specific to the external platform.

In some implementations, the method further includes: identifying, by the inline security platform, a rule of the inline security platform that indicates that the inline security platform is to perform the operation within the external platform based on the one or more actions performed by the external platform on the transmitted data violating the one or more security policies and based on the data being associated with the external platform, and wherein the rule of the inline security platform further indicates that the inline security platform is to perform a second operation within a second external platform based on the one or more actions performed by the external platform on the transmitted data not violating the one or more security policies and based on the data being associated with the second external platform, wherein the operation is different from the second operation.

In some implementations, the external platform comprises at least one of an email application, a communication platform, a large language model (LLM) platform, or a generative artificial intelligence platform.

In some implementations, performing the operation on the transmitted data within the external platform to remedy the violation of the one or more security policies includes: accessing a stored association between the operation and a function of the external platform; and using the function on the external platform to perform the operation.

In some implementations, the method includes in response to determining that at least one of the one or more actions performed by the external platform on the transmitted data violates the one or more security policies, performing, by the inline security platform, a second operation within the inline security platform, wherein the operation is different from the second operation.

In some implementations, performing the second operation includes blocking transmission of the data.

In some implementations, the operation includes at least one of an email quarantine operation within the external platform, a reconfiguration of a user status within the external platform, blocking outside user access to the data within the external platform, or transmission of a message using the external platform.

In some implementations, performing the operation on the transmitted data includes: identifying, by the inline security platform, a label associated with the data at the external platform, wherein the label represents a security level for the data identified and assigned by the external platform; determining, by the inline security platform, whether the label associated with the data by the external platform violates the one or more security policies; in response to determining the label associated with the data violates the one or more security policies, generating, by the inline security platform, another label to associate with the data that does satisfy the one or more security policies; removing, by the inline security platform, the label associated with the data; and storing, by the inline security platform, the data and the other label associated with the data in the external platform.

The details of one or more implementations of the subject matter of the disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a system including an inline security platform, according to some implementations of the present disclosure.

FIG. 2 shows an example of a computing system, according to some implementations of the present disclosure.

FIG. 3 is a flow chart that illustrates an example process for techniques performed by an inline security platform.

Like reference numbers and designations in the various drawings indicate like elements.

### DETAILED DESCRIPTION

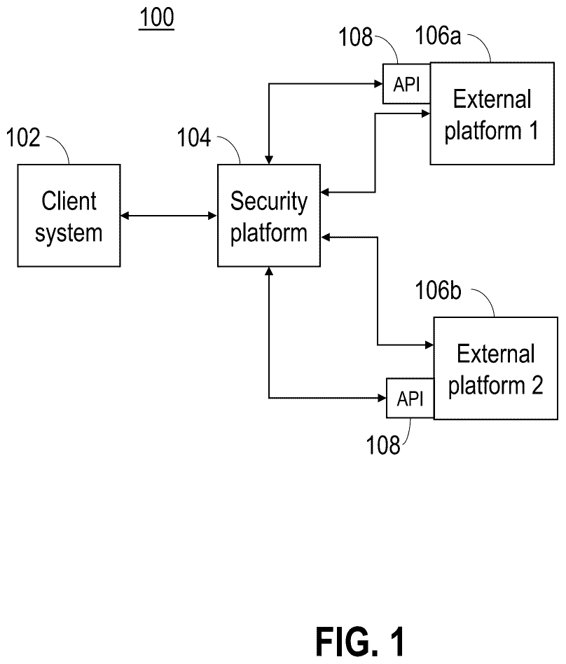

Inline security platforms are configured directly in data transmission paths between computer platforms, analyzing, modifying, and/or blocking data as the data passes through the security platforms. For example, in FIG. 1, in a system 100, an inline security platform 104 is configured to monitor communications between a client system 102 (for example, a user device, a server, a client device, a computer system, etc.) and multiple external platforms. In this example, two external platforms 106a, 106b (referred to collectively as external platforms 106) are in communication with the client system 102. The communication between the security platform 104, the client system 102, and the external platforms 106 can be performed over one or more networks, e.g., the Internet, local networks, cellular networks, etc. Inline security platforms can be configured as, for example, firewalls, security service edge (SSE), proxies, and/or the like. The security platform 104 can execute in the cloud and/or in a local device of the client system 102.

According to some implementations of the present disclosure, an inline security platform is advantageously configured to perform platform-integrated operations in one or more external platforms 106. In some implementations, this configuration can provide improved flexibility by permitting application-specific responses to given data conditions, event detections, etc. Further, in some implementations, this configuration can provide more effective security maintenance, e.g., by allowing more extensive responses to security events, and/or more options for responding to security events, compared to, for example, operations such as “block data” or “send alert” which may be performed by the security platform without integration with an external platform.

The security platform 104 can operate based on a policy framework including one or more types of rule bases, e.g., SSL rules, application rules, DLP rules, URL filtering rules, etc. The rules specify how the security platform 104 should respond to various types of data, communications requests, network connections, etc. For example, the security platform 104 may block certain data or access to certain networks and/or websites, send notifications/alerts in response to certain data and/or communications, etc. The security platform 104 can have security features implemented in profiles attached to the rule base(s), and/or can have separate rule bases for different security features.

An example of a rule is the following:

Matching criteria
-Source IP
-User/group
-Application
-[etc.]
URL filtering rule:
-Gambling -> block page
-Others -> allow
Logging

In this example, the “matching criteria” indicate to what users/entities the rule is to apply, and/or in what situations the rule is to apply. For example, the rule can apply to users having a certain role in an organization, can apply to devices (e.g., client systems 102) having certain IP addresses, can apply to external platforms 106 having certain IP addresses and/or associated with certain applications, etc. The URL filtering rule indicates how the security platform 104 is to respond to certain URLs, when the rule is active/applicable. In this example, the security platform 104 is configured to block URLs associated with gambling, and allow other URLs. The blocking operation is an operation within the security platform 104, acting on data passing through the security platform 104. This example of a rule further includes a logging configuration indicating how security events (e.g., blocking of gambling URLs) are to be recorded.

According to some implementations of the present disclosure, an inline security platform is configured to perform operations on, with, and/or in the external platforms 106, e.g., in association with security rules. For example, the inline security platform 104 can be configured to, based on one or more criteria being satisfied (e.g., as set forth in a rule), access an external platform 106 and perform application-specific operations within the external platform. These platform-integrated access and operations, when applied to security platforms configured as inline security platforms, have been found to be particularly advantageous.

The access and operations can be performed using, for example, one or more suitable application programming interfaces (APIs) 108 associated with the external platforms 106. Access by the security platform 104 to the APIs 108 can be distinct from access to data being transmitted between the client system 102 and the platforms 106. For example, in some implementations, the security platform 104 can block and/or modify data transmitted between the client system 102 and the platforms 106 (as an inline security platform) and, separately, access the APIs 108 to perform platform-specific operations on/in the platforms 106.

As an example, the following rule can be applied to a client system 102 that receives email using multiple email platforms:

```
  Matching criteria
  -User A
  - Corp network 10.0.0.0/0
  -[Email platform 1], [Email platform 2]
  Email rule
  -Phishing ->
    -Block
    -[Email platform 1] action: Quarantine
    -[Email platform 2] action: Quarantine, forward to
phishing@example.com
  - Others -> allow
  Logging
  -Send alert
```

In this example, an email filtering rule applies to “User A” operating in a predetermined corporate network. When an email is received that is determined to be a phishing email, the security platform 104 blocks the email, for example, prevents the email from being received by User A's browser or email application. Blocking the email can be an operation performed within the security platform 104.

Further, if the email is received using a first email platform, the security platform 104 performs a “quarantine” action within the first email platform. If the email is received using a second email platform, the security platform 104 performs a “quarantine” action within the second email platform and also forwards the phishing email to a specified phishing address using the second security platform.

In this case, the “quarantine” and “forward” actions are platform-integrated operations distinct from blocking and logging operations that may be performed by the security platform 104 internally and/or by accessing the client system 102. For example, the “quarantine” action can correspond to an action that may be performed by a user by (i) selecting the email in a user interface of the email platform, such as a website or mobile application, (ii) opening a contextual menu in the user interface, and (iii) selecting “quarantine” in the menu. For example, quarantining the email may include moving the email into a particular folder within the email platform. The security platform 104 can perform these and/or other actions using APIs of the first and second email platforms, to cause internal process(es) within the email platforms that result in the phishing email being quarantined within the email platforms and, in the second of the second email platform, being forwarded by the second email platform.

Another example of a platform-integrated security rule is the following:

```
Matching criteria
-User B
- Corp network 10.0.0.0/0
-[Chat platform]
Chat rule
-Proprietary code leak ->
  -Block
  -[Chat platform] action: remove user
-Others -> allow
Logging
-Send alert
```

This example relates to an external chat application, e.g., a cloud-based team communication platform. In the case of a proprietary code leak (e.g., proprietary code detected in a message sent by User B), the security platform 104 is configured to block the message, e.g., use its capability as an inline security platform to block the message from being sent from the client system 102 to the external chat application, which is an external platform 106. Further, the inline security platform 104 is configured to remove the user as an authorized user of the chat platform (e.g., remove the user from participation in a chat, team, group, etc.). Removal of the user is an operation within the chat application, e.g., making use of external-platform-side tools to perform operations on server(s) of the external platform 106. The security platform 104 can access an API 108 of the external platform 106 corresponding to the chat application, and can use suitable command(s) of the chat application in the API 108 to perform the removal action.

In some implementations, the security platform 104 is configured to use predetermined API commands, API functions, and/or other API tools (collectively referred to as “functions”) to perform the corresponding platform-integrated operations. These commands, functions, and/or tools can be specific to each different external platform 106 and/or can be common among multiple external platforms 106. For example, the “quarantine” operation discussed above may be performed using different API functions for the two different email platforms. Further, the “quarantine” operation itself may be different between the two different email platforms. The commands, functions, and/or tools can be stored in the security platform 104 in association with the corresponding external platforms 106 and/or rules to which the commands, functions, and/or tools are applicable.

In some implementations, the security platform 104 can perform active discovery of data stored on the external platforms 106. The security platform 104 can determine whether the data that is discovered on each of the external platforms 106 is in accordance or not with one or more security policies. In some cases, the external platforms 106 may store and utilize data that satisfies the one or more security policies. However, in some cases, the external platform may store and utilize data in a manner that is inconsistent with the one or more security policies. The data may have been overshared by a client device to the external platform, an external platform may have connected to a third-party application to access the data that is in violation of the one or more security policies, or the external platform may modify data provided to it by a client device in a manner that violates the one or more security policies, to name some examples. The security platform 104 can perform one or more actions in response to determining the data stored and utilized by a respective external platform violates the one or more security policies.

In some implementations, the security platform 104 can retrieve the data and associated metadata that describes the data stored on the external platform through a corresponding API. In some cases, the security platform 104 can access and retrieve the data through the API of a corresponding external platform on a regular or irregular basis. For example, the security platform 104 can access and retrieve the data from the external platform every hour, every day at a set time, every day, or on another periodic basis. In some examples, the security platform 104 can access and retrieve the data from the external platform when client system 102 requests to access data from an external platform or when the external platform 106a connects to a third-party application. Other events that are detectable by the security platform 104 can be used as triggering events that cause the security platform 104 to access and retrieve data the respective external platform.

The security platform 104 can retrieve various types of data from the external platform through its corresponding API. The data can include, for example, a file, a portion of software code, a financial document, a multimedia image, a folder, or another data type. The external platform can store data locally or store data in the cloud or other locations accessible by the external platform. In addition, the security platform 104 can access metadata that describes the data. The metadata can include, for example, a type of the asset, a timestamp associated with the asset, and permissions associated with the data. The security platform 104 can analyze the data and the types of data to determine whether a security violation has occurred. In response to determining whether a security violation has occurred, the security platform 104 can perform one or more actions, as will be described below.

Each external platform can generate a label that categorizes the data. The categorization of the data can include one or more classifications that indicate security permissions of the data to the external platform. The external platform can assign the label to the data for classification purposes. The assignment can include, for example, affixing the label to the data, appending the label to the data, attaching the label to the data, associating the label to the data, or storing an identifier or link in database that associates the label with the data, to name a few examples. The security level can indicate a type of security permission that include, for example, Personal, Public, General, Confidential, and Highly Confidential. The external platform can use these labels to determine whether the data can be accessed by third party applications connected to the external platform, accessed by third party applications connected to the client devices, shared with a different client device, or even shared with any other external platforms, to name a few examples. The Personal categorization defines the data to be personalized information shared only with a respective client device. The Public categorization defines the data to be information shared with everyone. The General categorization defines the data to be information shared with a specific organization. The Confidential categorization defines the data to be information shared with a certain group of individuals, devices, or applications that have access to a Confidential level of information. Lastly, the Highly Confidential categorization defines the data to be information shared with a certain, more restrictive, group of individuals, devices, or application that have access to a Highly Confidential level of information.

In some implementation, the security platform 104 can determine whether the data can be shared to one or more other applications, devices, or users, according to the affixed labels. According to the security level of the affixed labels, the security platform 104 can determine which applications, which devices, and/or which users have access to the data. For example, the security platform 104 can determine that data with a Public label indicates that a third party application, such as a third party large language model (LLM), can access the data on the external platform. However, in another example, the security platform 104 can determine that data with a Confidential or Highly Confidential label indicates that the third party LLM cannot access the data on the external platform.

If the security platform 104 determines that the external platform affixed a label to the data that is in violation of or conflicts with one or more security policies, then the security platform 104 can determine that data has been overshared or shared and in violation of the one or more security policies. Moreover, the security platform 104 can determine what applications or other devices this data has been shared with, which user has accessed this data in the past, whether the data is being shared appropriately or inappropriately, and whether the data is being overshared, based on the affixed label to the data.

In some implementations, the security platform 104 can perform one or more security actions in response to determining whether the data stored or accessed by the external platform is in violation with one or more security policies. These security actions can be performed according to a severity of the violation of one or more security policies or a risk of information exposure. Depending on the determined severity, the security platform 104 can perform a security action related to a first level of mitigation, a second level of mitigation, and/or a third level of mitigation. The severity of the violation or risk of exposure determines the security response.

For instance, if the security platform 104 determines that a file on the external platform 106a is labeled with a value of “Public” and the one or more security policies of that same file indicate the file should only be shared with the user “John”, then security platform 104 may notify the user John that his file is being shared publicly on the external platform 106a. Then, the security platform 104 can alert a security professional of the publicly shared data on the external platform 106a, provide a terminal to the security professional with one or more commands, e.g., PowerShell or Python commands, to remove the data from the external platform 106a. This can be performed if the security platform 104 determines the severity aligns with the first level of mitigation.

In some examples, if the security platform 104 determines the severity aligns with the second level of mitigation, such as the data on the external platform 106b is being overshared with a third party LLM, then the security platform 104 can generate a new label to attach to the data, in a second level of mitigation. This new label can recite, for example, “Personal” or “Confidential,” depending on the information in the data. The new label can ensure that the external platform 106b does not cause the data to be shared to other applications, devices, or users, does not index the data on the external platform 106b, or increases the security permissions on the data. In response to generating the new label, the security platform 104 can remove the old label or various old labels, affix the new label to the data, and send the data with the new label to external platform 106b. This will ensure the external platform 106b effectively manages the data and follows the one or more security policies set by the security platform 104. In this manner, the security platform 104 can ensure that the external platform 106b properly maintains and secures the data according to the attached new label.

In some examples, if the security platform 104 determines the severity aligns with the third level of mitigation, such as the data on the external platform 106a is being overshared with different users and the data is of Highly Confidential nature, then the security platform 104 can promptly remove outside access to the data on the external platform 106a. Moreover, the security platform 104 can determine whether an amount of time that has elapsed from an initial share by the client system. If the security platform 104 determines the amount of time that has elapsed satisfies a threshold value, e.g., 10 seconds, 1 hour, or more, then the security platform 104 can flag this overshare as a third level of mitigation. In response, the security platform 104 can remove outsiders, e.g., devices, applications, or users, from accessing the data from the external platform 106a. In some cases, removing outsides from accessing the data from the external platform 106a can include the security platform 104 affixing a new label to the data that recites “Highly Confidential” to ensure the external platform 106a does not share the data to users outside the external platform 106a. Other configurations are also possible.

In some implementations, the security platform 104 may prompt the client system 102 or a security professional in response to detecting a security violation. For instance, in response to the security platform 104 detecting a particular level of mitigation, e.g., first, second, or third level of mitigation, the security platform 104 can either perform an automatic action to fix the issue or prompt the client system 102 with one or more security actions to perform. The user at the client system 102 or the security professional can select one or more of the security actions to perform, such as through a user interface of the client system 102 or another means. In response, the security platform 104 can perform the selected one or more security operations, e.g., removing outsiders access, attaching a new label to the data, and storing the data with the new label on the external platform, removing the data from the external platform, and other actions, to name a few examples.

In some cases, the security platform 104 can automatically remove the data from the external platform 106a, for example, if a security violation is detected and an elapsed period has satisfied a threshold value. This obviates the need for user confirmation or user selection of security action. However, in some cases, the user at the client system 102 or the security professional can override an automatic action performed by or planning to be performed by the security platform 104 and instead perform the override security action. Based on the detected action and the mitigated action, the security platform 104 can perform one or more security actions when one or more security policies are in violation.

The external platforms 106 can include any suitable type of platform, such as email platforms, chat/communication platforms, web browsers, web servers, enterprise platforms, large language model (LLM) platforms, generative artificial intelligence platforms, etc.

### Example Computer Systems

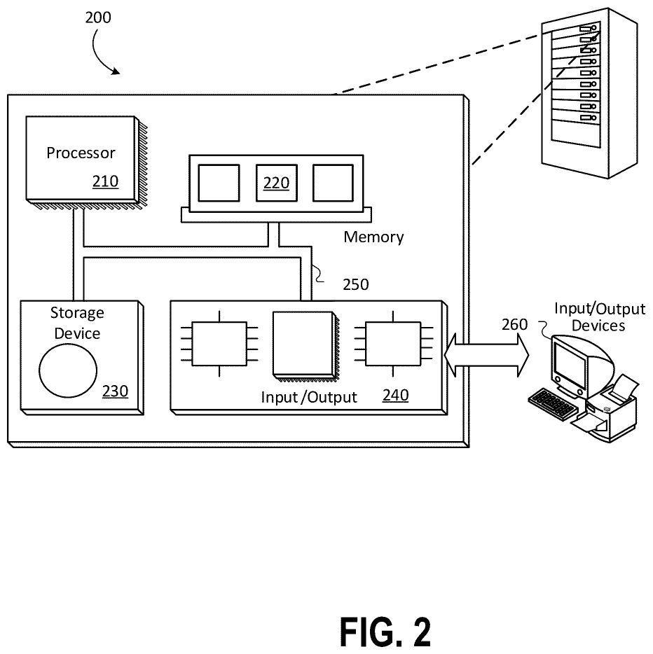

FIG. 2 depicts an example of a computing system, according to implementations of the present disclosure. The system 200 may be used for any of the operations described with respect to the various implementations discussed herein. For example, the system 200 can be or include the client system 102, the security platform 104, and/or an external platform 106.

The system 200 may include one or more processors 210, a memory 220, one or more storage devices 230, and one or more input/output (I/O) devices 260 controllable through one or more I/O interfaces 240. The various components 210, 220, 230, 240, or 260 may be interconnected through at least one system bus 250, which may enable the transfer of data between the various modules and components of the system 200.

The processor(s) 210 may be configured to process instructions for execution within the system 200. The processor(s) 210 may include single-threaded processor(s), multi-threaded processor(s), or both. The processor(s) 210 may be configured to process instructions stored in the memory 220 or on the storage device(s) 230. The processor(s) 210 may include hardware-based processor(s) each including one or more cores. The processor(s) 210 may include general purpose processor(s), special purpose processor(s), or both.

The memory 220 may store information within the system 200. In some implementations, the memory 220 includes one or more computer-readable media. The memory 220 may include any number of volatile memory units, any number of non-volatile memory units, or both volatile and non-volatile memory units. The memory 220 may include read-only memory, random access memory, or both. In some examples, the memory 220 may be employed as active or physical memory by one or more executing software modules.

The storage device(s) 230 may be configured to provide (e.g., persistent) mass storage for the system 200. In some implementations, the storage device(s) 230 may include one or more computer-readable media. For example, the storage device(s) 230 may include a floppy disk device, a hard disk device, an optical disk device, or a tape device. The storage device(s) 230 may include read-only memory, random access memory, or both. The storage device(s) 230 may include one or more of an internal hard drive, an external hard drive, or a removable drive.

One or both of the memory 220 or the storage device(s) 230 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 200. In some implementations, the CRSM may include a data store that provides storage of computer-readable instructions or other information in a non-transitory format. The CRSM may be incorporated into the system 200 or may be external with respect to the system 200. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 210 and the memory 220 may be supplemented by, or incorporated into, one or more application-specific integrated circuits (ASICs).

The system 200 may include one or more I/O devices 260. The I/O device(s) 260 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 260 may also include one or more output devices such as a display, LED(s), an audio output device (e.g., a speaker), a printer, a haptic output device, and so forth. The I/O device(s) 260 may be physically incorporated in one or more computing devices of the system 200, or may be external with respect to one or more computing devices of the system 200.

The system 200 may include one or more I/O interfaces 240 to enable components or modules of the system 200 to control, interface with, or otherwise communicate with the I/O device(s) 260. The I/O interface(s) 240 may enable information to be transferred in or out of the system 200, or between components of the system 200, through serial communication, parallel communication, or other types of communication. For example, the I/O interface(s) 240 may comply with a version of the RS-232 standard for serial ports, or with a version of the IEEE 1284 standard for parallel ports. As another example, the I/O interface(s) 240 may be configured to provide a connection over Universal Serial Bus (USB) or Ethernet. In some examples, the I/O interface(s) 240 may be configured to provide a serial connection that is compliant with a version of the IEEE 1394 standard.

The I/O interface(s) 240 may also include one or more network interfaces that enable communications between computing devices in the system 200, or between the system 200 and other network-connected computing systems. The network interface(s) may include one or more network interface controllers (NICs) or other types of transceiver devices configured to send and receive communications over one or more networks using any network protocol.

Computing devices of the system 200 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 200 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

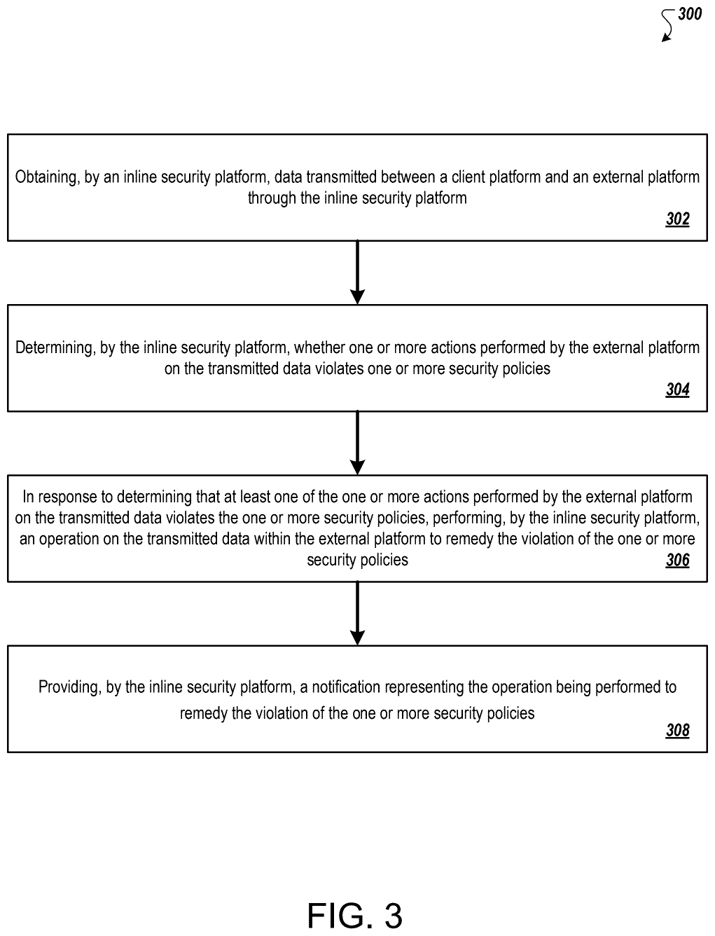

FIG. 3 is a flow chart that illustrates an example process 300 for techniques performed by an inline security platform. For example, the security platform 104 of FIG. 1 can perform the process 300.

The inline security platform or the security platform can obtain data transmitted between a client platform and an external platform through the security platform (302). The client platform can include, for example, a client device that is attempting to access or transmit data to the external platform. The external platform can include at least one of an email application, a communication platform, a large language model (LLM) platform, or a generative artificial intelligence platform. The data transmitted can include, for example, a file, a portion of software code, a financial document, a multimedia image, a folder, or another data type. Here, the security platform can obtain the data transmitted between the client platform and the external platform over a network, such as the Internet or other.

The security platform can determine whether one or more actions performed by the external platform on the transmitted data violates one or more security policies (304). In some cases, the security platform identifies a rule of the inline security platform that indicates that the inline security platform is to perform the operation within the external platform based on the one or more actions performed by the external platform on the transmitted data violating the one or more security policies and based on the data being associated with the external platform. The rule of the security platform further indicates that the inline security platform is to perform a second operation within a second external platform based on the one or more actions performed by the external platform on the transmitted data not violating the one or more security policies and based on the data being associated with the second external platform. The operation being performed is different from the second operation being performed.

The operation can include, for example, at least one of an email quarantine operation within the external platform, a reconfiguration of a user status within the external platform, blocking outside user access to the data within the external platform, or transmission of a message using the external platform. Other examples are also possible.

In response to determining that at least one of the one or more actions performed by the external platform on the transmitted data violates the one or more security policies, the security platform can perform an operation on the transmitted data within the external platform to remedy the violation of the one or more security policies (306). The security platform can perform the operation on the transmitted data within the external platform by accessing an application programming interface (API) of the external platform and executing one or more functions through the API to perform the operation within the external platform. The one or more functions through the API are functions that are specific to the external platform.

In some cases, performing the operation on the transmitted data within the external platform to remedy the violation of the one or more security policies can include, for example, the security platform accessing a stored association between the operation and a function of the external platform. Then, the security platform uses the function on the external platform to perform the operation.

In some cases, performing the operation on the transmitted data includes the security platform identifying a label associated with the data at the external platform, where the label represents or describes a security level for the data identified and assigned by the external platform. The security platform can determine whether the label associated with the data by the external platform violates the one or more security policies. In response to determining the label associated with the data violates the one or more security policies, the security platform generates another label to associate with the data that does satisfy the one or more security policies. The security platform removes the label associated with the data and stores the data and the other label associated with the data in the external platform.

In some cases, in response to determining that at least one of that at least one of the one or more actions performed by the external platform on the transmitted data violates the one or more security policies, the security platform can perform a second operation within the inline security platform, wherein the operation is different from the second operation. The second operation can include, for example, blocking transmission of the data. Other examples are also possible.

The security platform can provide a notification representing the operation being performed to remedy the violation of the one or more security policies (308). The notification can include, for example, a notification displayed to the client platform over a network or displayed to an administrator of the system. The notification may be displayed through a graphical user interface of the client platform.

This specification uses the term “configured” in connection with systems and computer program components. For a system of one or more computers to be configured to perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining, by an inline security platform, data transmitted between a client platform and an external platform through the inline security platform;
determining, by the inline security platform, whether one or more actions performed by the external platform on the transmitted data violates one or more security policies;
in response to determining that at least one of the one or more actions performed by the external platform on the transmitted data violates the one or more security policies, performing, by the inline security platform, an operation on the transmitted data within the external platform to remedy the violation of the one or more security policies; and
providing, by the inline security platform, a notification representing the operation being performed to remedy the violation of the one or more security policies.

2. The method of claim 1, wherein performing the operation on the transmitted data within the external platform comprises:
accessing, by the inline security platform, an application programming interface (API) of the external platform; and
executing one or more functions through the API to perform the operation within the external platform.

3. The method of claim 2, wherein the one or more functions of the API are specific to the external platform.

4. The method of claim 1, further comprising:
identifying, by the inline security platform, a rule of the inline security platform that indicates that the inline security platform is to perform the operation within the external platform based on the one or more actions performed by the external platform on the transmitted data violating the one or more security policies and based on the data being associated with the external platform, and
wherein the rule of the inline security platform further indicates that the inline security platform is to perform a second operation within a second external platform based on the one or more actions performed by the external platform on the transmitted data not violating the one or more security policies and based on the data being associated with the second external platform,
wherein the operation is different from the second operation.

5. The method of claim 1, wherein the external platform comprises at least one of an email application, a communication platform, a large language model (LLM) platform, or a generative artificial intelligence platform.

6. The method of claim 1, wherein performing the operation on the transmitted data within the external platform to remedy the violation of the one or more security policies comprises:
accessing a stored association between the operation and a function of the external platform; and
using the function on the external platform to perform the operation.

7. The method of claim 1, comprising:
in response to determining that at least one of the one or more actions performed by the external platform on the transmitted data violates the one or more security policies, performing, by the inline security platform, a second operation within the inline security platform, wherein the operation is different from the second operation.

8. The method of claim 7, wherein performing the second operation comprises blocking transmission of the data.

9. The method of claim 1, wherein the operation comprises at least one of an email quarantine operation within the external platform, a reconfiguration of a user status within the external platform, blocking outside user access to the data within the external platform, or transmission of a message using the external platform.

10. The method of claim 1, wherein performing the operation on the transmitted data comprises:
identifying, by the inline security platform, a label associated with the data at the external platform, wherein the label represents a security level for the data identified and assigned by the external platform;
determining, by the inline security platform, whether the label associated with the data by the external platform violates the one or more security policies;
in response to determining the label associated with the data violates the one or more security policies, generating, by the inline security platform, another label to associate with the data that does satisfy the one or more security policies;
removing, by the inline security platform, the label associated with the data; and
storing, by the inline security platform, the data and the other label associated with the data in the external platform.

11. A system comprising:
one or more computers and one or more storage devices storing instructions that are operable, when executed by the one or more computers, to cause the one or more computers to perform operations comprising:
obtaining, by an inline security platform, data transmitted between a client platform and an external platform through the inline security platform;
determining, by the inline security platform, whether one or more actions performed by the external platform on the transmitted data violates one or more security policies;
in response to determining that at least one of the one or more actions performed by the external platform on the transmitted data violates the one or more security policies, performing, by the inline security platform, an operation on the transmitted data within the external platform to remedy the violation of the one or more security policies; and
providing, by the inline security platform, a notification representing the operation being performed to remedy the violation of the one or more security policies.

12. The system of claim 11, wherein performing the operation on the transmitted data within the external platform comprises:
accessing, by the inline security platform, an application programming interface (API) of the external platform; and
executing one or more functions through the API to perform the operation within the external platform.

13. The system of claim 12, wherein the one or more functions of the API are specific to the external platform.

14. The system of claim 11, further comprising:
identifying, by the inline security platform, a rule of the inline security platform that indicates that the inline security platform is to perform the operation within the external platform based on the one or more actions performed by the external platform on the transmitted data violating the one or more security policies and based on the data being associated with the external platform, and
wherein the rule of the inline security platform further indicates that the inline security platform is to perform a second operation within a second external platform based on the one or more actions performed by the external platform on the transmitted data not violating the one or more security policies and based on the data being associated with the second external platform,
wherein the operation is different from the second operation.

15. The system of claim 11, wherein the external platform comprises at least one of an email application, a communication platform, a large language model (LLM) platform, or a generative artificial intelligence platform.

16. The system of claim 11, wherein performing the operation on the transmitted data within the external platform to remedy the violation of the one or more security policies comprises:
accessing a stored association between the operation and a function of the external platform; and
using the function on the external platform to perform the operation.

17. The system of claim 11, comprising:
in response to determining that at least one of the one or more actions performed by the external platform on the transmitted data violates the one or more security policies, performing, by the inline security platform, a second operation within the inline security platform, wherein the operation is different from the second operation.

18. The system of claim 17, wherein performing the second operation comprises blocking transmission of the data.

19. The system of claim 11, wherein the operation comprises at least one of an email quarantine operation within the external platform, a reconfiguration of a user status within the external platform, blocking outside user access to the data within the external platform, or transmission of a message using the external platform.

20. A non-transitory computer-readable medium storing software comprising instructions executable by one or more computers which, upon such execution, cause the one or more computers to perform operations comprising:
obtaining, by an inline security platform, data transmitted between a client platform and an external platform through the inline security platform;
determining, by the inline security platform, whether one or more actions performed by the external platform on the transmitted data violates one or more security policies;
in response to determining that at least one of the one or more actions performed by the external platform on the transmitted data violates the one or more security policies, performing, by the inline security platform, an operation on the transmitted data within the external platform to remedy the violation of the one or more security policies; and
providing, by the inline security platform, a notification representing the operation being performed to remedy the violation of the one or more security policies.
